(19) United States
(12) Patent Application Publication
(10) Pub. No.: US 2005/0050483 A1
(43) Pub. Date: Mar. 3, 2005

(54) System and method analyzing design elements in computer aided design tools

(76) Inventors: S. Brandon Keller, Evans, CO (US); Gregory Dennis Rogers, Fort Collins, CO (US); George Harold Robbert, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/647,596

(22) Filed: Aug. 25, 2003

(51) Int. Cl. G06F 17/50

(52) U.S. Cl. 716/4

(57) ABSTRACT

System and method for analyzing design elements in a CAD tool design. A configuration element generator encodes information in a configuration command to generate a configuration element associated with at least one of the design elements. A sequencer, coupled to the configuration element generator, tags the configuration element with a sequence number. A computer memory, coupled to the sequencer, stores the configuration element. A processor, coupled to the computer memory, applies, to the design element that is of interest, each stored said configuration element associated with the design element of interest, in an order indicated by the sequence number. A configuration element is an encoding of data comprising formatted information associated with a design.

### RELATED APPLICATIONS

The present document contains material related to the material of copending, cofiled, U.S. patent application Ser. No. ______ Attorney Docket Number 100111221-1, entitled System And Method For Determining Wire Capacitance For A VLSI Circuit; Ser. No. ______ Attorney Docket Number 100111227-1, entitled System And Method For Determining Applicable Configuration Information For Use In Analysis Of A Computer Aided Design; Ser. No. ______ Attorney Docket Number 100111228-1, entitled Systems And Methods Utilizing Fast Analysis Information During Detailed Analysis Of A Circuit Design; Ser. No. ______ Attorney Docket Number 100111230-1, entitled Systems And Methods For Determining Activity Factors Of A Circuit Design; Ser. No. ______ Attorney Docket Number 100111232-1, entitled System And Method For Determining A Highest Level Signal Name In A Hierarchical VLSI Design; Ser. No. ______ Attorney Docket Number 100111233-1, entitled System And Method For Determining Connectivity Of Nets In A Hierarchical Circuit Design; Ser. No. ______ Attorney Docket Number 100111235-1, entitled System And Method For Determining Unmatched Design Elements In A Computer-Automated Design; Ser. No. ______ Attorney Docket Number 100111236-1, entitled Computer Aided Design Systems And Methods With Reduced Memory Utilization; Ser. No. ______ Attorney Docket Number 100111238-1, entitled System And Method For Iteratively Traversing A Hierarchical Circuit Design; Ser. No. ______ Attorney Docket Number 100111257-1, entitled Systems And Methods For Establishing Data Model Consistency Of Computer Aided Design Tools; Ser. No. ______ Attorney Docket Number 100111259-1, entitled Systems And Methods For Identifying Data Sources Associated With A Circuit Design; and Ser. No. ______ Attorney Docket Number 100111260-1, entitled Systems And Methods For Performing Circuit Analysis On A Circuit Design, the disclosures of which are hereby incorporated herein by reference.

### BACKGROUND

Computer aided design (CAD) tools and computer aided engineering (CAE) tools are used to create and analyze various types of designs. Hereinafter, a CAD tool and a CAE tool are both referred to simply as a CAD tool. The designs are used to support a variety of fields, such as architecture, civil engineering, mechanical engineering, and electrical engineering. An M-CAD tool and an E-CAD tool are two types of CAD tools. An M-CAD tool creates and analyzes mechanical engineering designs and an E-CAD tool creates and analyzes electrical/electronic engineering designs, such as schematics of an electronic circuit.

A CAD tool performs numerous calculations. These calculations can include design calculations as well as analysis calculations. The analysis calculations are used to determine characteristics of engineering components used in the designs. Hereinafter, engineering components in a design are referred to as design elements. For example, the E-CAD tool can determine resistances, capacitances, and connections of design elements, such as wires and transistors, used in the electronic designs. These combined design and analysis calculations consume a large portion of processor power and memory space of a computer system when operating the CAD tool.

A large design is inherently complex; thus, the calculations performed by the CAD tool are numerous and lengthy. An example of a large design is a microprocessor design, such as that of an Itanium family microprocessor produced by Intel Corporation or a Precision Architecture-Reduced Instruction Set Computer (PA-RISC) microprocessor produced by Hewlett Packard Corporation. Presently, such a microprocessor can include over one billion design elements. The design elements of a microprocessor are transistors, wires, resistors, and various other semiconductor components and devices. To further complicate microprocessor design, the number of design elements typically increases as processor technology advances.

Presently, CAD tool calculations performed by an analysis module on a design are numerous and may last many hours or even days. For example, an engineer may design one new portion of a microprocessor. The engineer may next analyze that new portion in the CAD tool and then reanalyze the entire design to determine if the new portion is acceptable. When calculations are performed on designs having a billion design elements or more, a determination of whether the new portion is acceptable may not be made until the next day or beyond, since the CAD tool may need to perform complex calculations on large designs that include large amounts of data. Furthermore, physical limits of computer memory may make performing the complex calculations an impossibility. Since the analysis is a time consuming process, productivity may be lost, as engineers must wait for analysis results. Continuous lost productivity due to lengthy development times slows technology advancement and can result in significant costs, as well as lost business.

### SUMMARY

The present system provides a method for analyzing design elements in a CAD tool design. For each configuration command in a configuration file, information in the configuration command is encoded to generate a configuration element; the configuration element is ordered with a sequence number indicating the order in which the configuration command appeared in the configuration file; and the configuration element is stored in computer memory. For each design element of interest, each of the configuration elements stored in computer memory is applied to the design element of interest in an order indicated by the sequence number, to analyze the design.

The present system includes a configuration element generator for encoding information in a configuration command to generate a configuration element associated with at least one of the design elements. A sequencer is coupled to the configuration element generator for tagging the configuration element with a sequence number. Computer memory stores the configuration element and a processor applies, to the design element that is of interest, each stored configuration element associated with the design element of interest, in an order indicated by the sequence number.

### BRIEF DESCRIPTION OF THE DRAWINGS

A more complete understanding of the present system may be obtained by reference to the drawings, in which:

FIG. 1 shows an exemplary embodiment of a CAD system;

FIG. 2 is a flowchart illustrating an exemplary set of steps performed in operation of the system of FIG. 1; and

FIG. 3 is a diagram illustrating an alternative exemplary CAD system.

### DETAILED DESCRIPTION

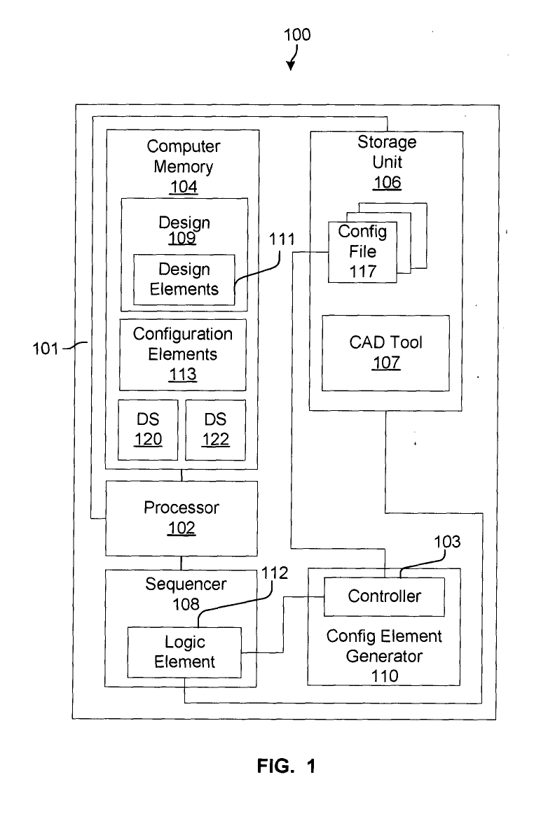

FIG. 1 shows CAD system 100 configured for generating configuration elements 113, in accord with one embodiment of the present system. A configuration element is an encoding of data comprising formatted information associated with a design. More specifically, a configuration element is an encoding of information contained in a configuration command (described below). Multiple configuration elements may pertain to a single design element, and a single configuration element may pertain to multiple design elements. For example, in some instances multiple configuration elements can be used to describe individual characteristics of a design element, while in other instances one configuration element can be used to describe all of the characteristics of one particular design element. A design element (i.e., of design elements 111) is a single component, a net, or a group of elements of design 109 that structurally define the design generated by CAD tool 107. For example, an electronic design generated by an E-CAD tool may include design elements such as transistors (e.g., Metal Oxide Semiconductor Field Effect Transistors, or ‘MOSFET’s), wires, resistors, capacitors, power supplies, diodes, operational amplifiers, hierarchical sub-designs, and logic gates, that are analyzed using associated configuration elements in accordance with the present system. Thus, configuration elements 113 are associated with design 109, as they have information pertaining to the design elements of the design. Configuration elements 113 may be employed in the analysis of M-CAD tool designs as well as E-CAD tool designs. A mechanical design generated by an M-CAD tool may include design elements such as metal structures, gears, fluids, joints, and connectors.

As shown in FIG. 1, CAD system 100 includes computer system 101. Computer system 101 controls CAD tool 107 to analyze design 109. Design 109 is developed by CAD tool 107 and includes design elements that are relevant to a type of design that is created. For example, an E-CAD tool may create a VLSI design having a plurality of design elements that are transistors and/or other electronic components. Analysis of design 109 includes analyzing configuration elements 113 using computer system 101. Computer system 101 includes processor 102, computer memory 104, and storage unit 106. In computer system 101, processor 102 is coupled to computer memory 104 and to storage unit 106 for operating CAD tool 107. CAD tool 107 initially resides in storage unit 106 as software instructions. Upon initializing CAD tool 107, sets of the software instructions that form CAD tool 107 are loaded in computer memory 104. At least part of design 109 is also loaded in computer memory 104 upon initialization of CAD tool 107. Processor 102 then executes the sets of CAD tool instructions.

In CAD system 100, computer system 101 further includes configuration element generator 110 and sequencer 108. Configuration element generator 110 generates configuration elements 113. Sequencer 108 is coupled to configuration element generator 110 for sequencing the configuration elements 113 with a sequence number as determined by analysis of the design 109. The sequence number is a number or other indicia that can be used to specify the relative order of application of a particular configuration element. The sequence number represents an association of the particular configuration element to the order of the configuration command that is used to generate that particular configuration element. The sequence number is used to form a sequenced list of configuration elements that are associated with particular design elements.

Each configuration element is generated by encoding a configuration command from configuration file 117. Configuration commands are functions that are used for setting physical and/or electrical characteristics of design elements, such as the resistance of a wire. Configuration commands are read from configuration files 117 in the order set forth in the configuration files. The order of the configuration commands establishes the sequence number for each of the configuration elements to be generated.

Configuration files 117 are storage structures within storage unit 106 that contain configuration commands. An example of a configuration file for an E-CAD design is shown in the Sample Configuration File below, which contains six configuration commands.

Sample Configuration File

| Configuration | Design Element | | |
|---|---|---|---|
| Command Type | Specifier | Value | Description |
| voltage | VDD | 2.1 V | Set the supply |
| | | | voltage |
| voltage | GND | 0 V | Set the ground |
| | | | voltage |
| wire_cap | inst1/guts/input | +2 pF | Increase wire |
| | | | capacitance 2 pF |
| af | */scan/shift | 0.1 | Activity factor = 0.1 |
| ignore_net | testjig/happy/* | | Ignore all nets |
| | | | in testjig/happy |
| power | * | *1.1 | Increase all net |
| | | | power by 10% |

In the present exemplary embodiment, each configuration command in the configuration file 117 has a Configuration Command Type field, a Design Element Specifier Field, a Value Field, and an optional Description Field. The fields, when used in combination, establish the characteristics of the design elements. For example, the first line of the Sample Configuration File (i.e., “voltage VDD 2.1 V”) is used to set a supply voltage of a design element to 2.1 Volts.

A design element specifier comprises a description of a design element, and is used for identifying design elements 111 by type. The design element specifier is ‘complete’ when it indicates one design element, and ‘partial’ when it can indicate multiple design elements. A complete specifier names a design element, and is thus the name of a specific design element, or the net name of a specific net instance. A partial specifier is a ‘regular expression’ for a net name, and describes applicable design element names. A regular expression is a string of characters used to represent one or more target strings that satisfy the pattern described by the regular expression. In the Sample Configuration File shown above, design element specifiers “*/scan/shift”, “testjig/happy/*”, and “*” are partial specifiers, and thus are regular expressions, in the present system. Using the design element specifiers to identify design elements 111 expedites searches for associated configuration elements when a particular type of design element is being analyzed more than once. In the Sample Configuration File shown above. design element specifier “GND” arid “VDD” are complete specifiers since they indicate one design element only.

In CAD system 100, computer memory 104 stores configuration elements 113 by design element specifiers in sequence number order such that an appropriate configuration command can be reused for other instances of a particular configuration element. For example, when a certain design element type is being analyzed more than once, an associated configuration element can be found in computer memory 104 and reused for analysis based on past analysis of the certain design element type.

Computer memory 104 stores single copies of configuration elements 113 by their association with design elements 111. For example, in an E-CAD design, computer memory 104 stores an association of a particular configuration element as it relates to a design element such that the particular configuration element can be reused when another identical design element is encountered. Computer memory 104 also stores design element specifiers and sequence numbers of configuration elements to decrease the analysis time required by processor 102. Processing time is decreased since the processor can find certain configuration elements based on the design element specifiers and sequence numbers without having to recalculate all applicable information for a configuration element.

In one embodiment, configuration element generator 110 includes controller 103 for selecting and reading the configuration files 117 that hold the configuration commands used to generate the configuration elements 113. Controller 103 continues selecting a configuration file until each of configuration files 117 is selected. Controller 103 is also receives requests for specific configuration elements and searches for the specific configuration elements in computer memory 104 so as to provide an interface between software that performs analysis of the design 109 and software that stores and manages the configuration elements 113.

In one embodiment, sequencer 108 includes logic element 112 coupled to controller 103 for generating a list of configuration elements being used in the analysis of design 109. Once the configuration elements are generated by configuration element generator 110, the configuration elements are added to a list. Sequencer 108 then orders the configuration elements by sequence number such that the newly sequenced list of configuration elements correlates with the order of the design elements under analysis.

As described herein, CAD system 100 reduces the amount of computer memory 104 required to analyze a given circuit. This reduction in required memory is accomplished by storing a single copy of each configuration element in computer memory 104 and creating a sequenced list of copies of configuration elements when CAD tool 107 requests a list of configuration elements for subsequent instantiations of the design elements 111. Analysis of the design elements 111 employs partial and/or complete specifiers to identify instantiations of circuit elements that match the specifiers. During the analysis process, all of the configuration elements associated with a particular partial specifier are copied into the sequenced list. Once analysis of design elements is complete, the lists of configuration elements are discarded, thereby further decreasing the amount of necessary computer memory. CAD system 100 enables analysis of a design without requiring the entire design to be resident in computer memory 104 at a given time.

In an exemplary embodiment, processor 102 incorporates functionality of configuration element generator 110, controller 103, sequencer 108, logic element 112. For example, items 110, 103, 108, 112 may take the form of one or more software modules resident within computer memory 104 that direct processor 102 to operate accordingly.

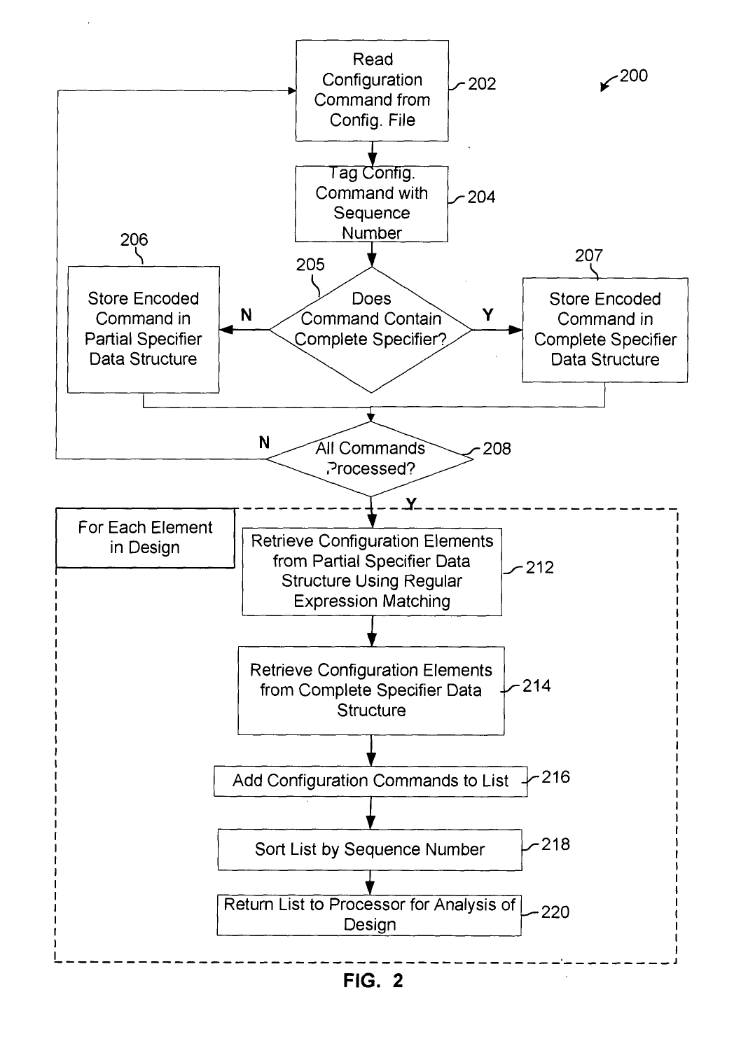

FIG. 2 is a flow chart illustrating exemplary operation 200 of system 100. As shown in FIG. 2, operation 200 commences when controller 103 reads a command from configuration file 117, in step 202. The configuration file includes a list of configuration commands that are used for generating configuration elements. Sequencer 108 then tags the configuration command with a sequence number for ordering the configuration commands, in step 204. The controller 103 then determines if the configuration command contains a partial or a complete specifier, in step 205. Regular expressions are used as partial specifiers in the present embodiment to identify design elements in design 109.

If the configuration command includes a partial specifier (e.g., a regular expression in the present embodiment), a configuration element encoded from the configuration command is stored in a data structure 120 used for storing only configuration commands that include partial specifiers, in step 206. If the configuration command contains a complete specifier, i.e., if it completely specifies a design element, a configuration element encoded from the configuration command is stored in a data structure 122 used for storing configuration elements that are complete specfiers. Complete specfiers apply directly to design elements that exist within design 109 (i.e., configuration elements designate specific design elements, net names, or blocks in the design), in step 207. In the present embodiment, data structure 122 stores the configuration elements by characteristic or type. For example, the following configuration commands
wire_Cap Element1=120 pf
voltage Element1+0.1V
voltage Element2 2.5V
   have one corresponding entry in the data structure 122 for a design element named ‘Element1’ and one corresponding entry for a design element named ‘Element2’. In this example, Element1 has two associated configuration elements and Element2 has one associated configuration element. The two design element names, Element 1 and Element 2, indicate the association between the configuration commands and the two corresponding design elements:
Element1->[(wire_cap=120 pf), (voltage+0.1V)]
Element2->[(voltage=2.5V)].

Once a configuration element is assigned to its appropriate data structure, controller 103 determines if every configuration command within the configuration file has been processed, in step 208. If not, the controller 103 returns to step 202 to continue processing commands until all commands have been processed. Steps 202-208 are summarized below in algorithmic form in Table 1.

TABLE 1
Process Configuration Commands From Configuration File

Controller 103 reads a configuration command from the
configuration file 117;
Sequencer 108 tags the configuration command with a
sequence number;
Controller 103 determines if the configuration command
contains a partial specifier; If the configuration command is a partial
specifier, controller 103 encodes the command as a configuration
element and stores the configuration element in the partial specifier
data structure 120; if not, controller 103 stores the configuration
command, encoded as a configuration element, in the complete
specifier data structure 122;
Controller 103 determines if every configuration command within
the configuration files has been processed; If all configuration
commands have not been processed, lines in the configuration file are
read until all configuration commands are processed.

Controller 103 next evaluates each partial specifier/regular expression in the partial specifier data structure 120 to determine if a corresponding configuration element is found within the design element presently of interest, and retrieves all matching configuration elements into a priority queue, in step 212. If the evaluated regular expression matches a particular configuration element found within data structure 120, then controller 103 retrieves the appropriate configuration element into the queue, in step 212. Similarly, controller 103 determines if the name of the design element of interest is found within the complete specifier data structure 122 containing specific design element names and retrieves an appropriate configuration element into the priority queue, in step 214. It should be noted that steps 212 and 214 may be performed in reverse order.

Controller 103 creates a merged list of configuration elements that are associated with the particular design element, by merging the entries in data structures 120 and 122, in step 216. Sequencer 108 sorts the configuration elements in the priority queue by sequence number such that the configuration elements are listed in an order determined by the configuration files 117, in step 218. Sequencer 108 then returns the sorted list of configuration elements to processor 102 so that processor 102 can apply configuration elements in the list to the analysis of design 109, in step 220. Steps 212 through 220 are performed for each design element of interest in design 109, and are summarized below in algorithmic form in Table 2.

TABLE 2
Get Configuration Elements for a Particular Design element

Search for and retrieve the configuration elements matching a
design element of interest within data structure 122;
For each entry in data structure 120, if the evaluated partial
specifier/regular expression matches the design element of interest:
retrieve the configuration element;
Combine the two lists, sorted by sequence number, so that the
configuration elements are listed in an order determined by the
configuration files;
Return the list of configuration elements to processor 102 for
use in analysis of design 109.

After the configuration elements are returned, processor 102 can begin to analyze design 109 by applying configuration elements to the design element of present interest. Once analysis of the present design element is complete, processor 102 discards the applied configuration elements, thus freeing up computer memory 104. A summary of operation 200 is shown below in Table 3.

TABLE 3
Analyze Design

Read all configuration commands in the configuration files (Table 1);
For each design element in the design:
Get the configuration elements for this particular design element
(Table 2);
Apply the configuration elements to this design element;
Discard the configuration elements for this design element.

Operation 200 may be performed on very large designs without requiring that the entire design be resident in memory at once. This capability is important if the design is too large to fit into computer memory 104. Instructions that perform the operations described with respect to FIG. 2 may be stored in storage media or computer memory, and later retrieved therefrom and executed by processor 102 to operate in accordance with the present system. Examples of instructions include software, program code, and firmware. Examples of storage media include memory devices, tapes, disks, integrated circuits, and servers.

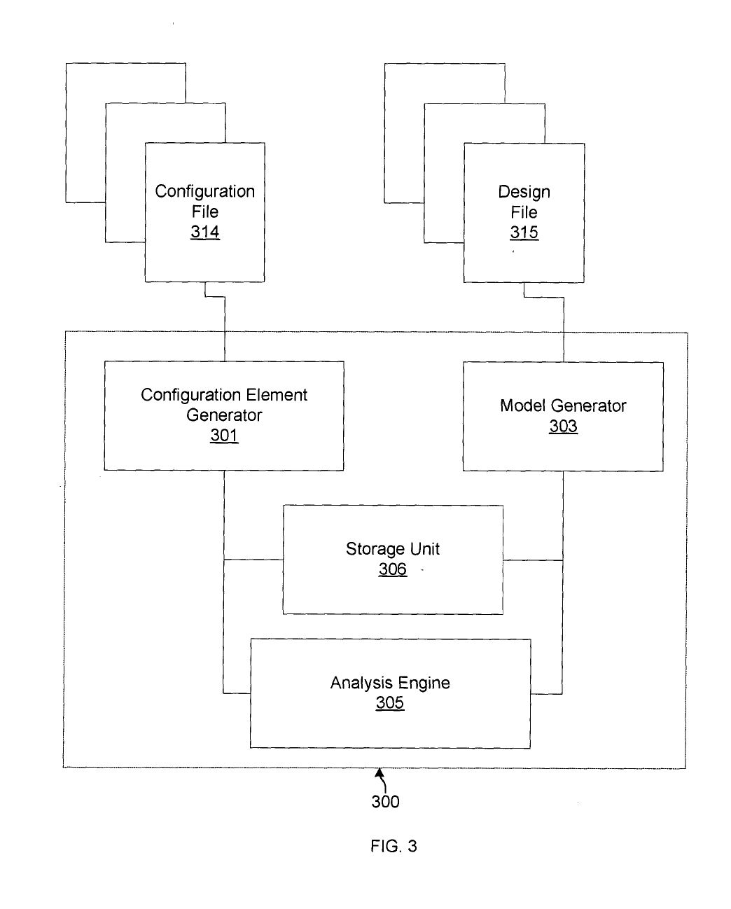

FIG. 3 shows an exemplary CAD tool system 300 that includes configuration element generator 301, model generator 303, storage unit 306, and analysis engine 305. As shown in FIG. 3, model generator 303 reads design elements from design files 315 to generate a design, such as design 109 of FIG. 1. The design includes a plurality of design elements and is stored in storage unit 306. Configuration element generator 301 reads configuration files 314 to generate configuration elements used for analyzing the design elements. The configuration elements are stored in storage unit 306 using complete and/or partial design element specifiers.

Analysis engine 305 is coupled to storage unit 306 for analyzing a particular design. The analysis engine 305 performs calculations and analysis of the design elements (e.g., design elements 111) by applying configuration elements that are associated with the design elements. Analysis engine 305 analyzes one or more design elements of the particular design at a time, since some designs are simply too large to fit in available computer memory (i.e., too many design elements in a given design). In the present embodiment, certain configuration elements are reused during analysis. For example, when multiple instantiations of a design element are encountered by analysis engine 305, analysis engine 305 locates and uses previously determined configuration elements in storage unit 306. This re-use of configuration elements reduces the number of configuration elements in memory at one time. Computer memory usage may also be reduced by storing a single copy of each configuration element that is available when the analysis determines another instance of the particular configuration element.

Since certain changes may be made in the above methods and systems without departing from the scope, one intention is that all matter contained in the above description or shown in the accompanying drawings be interpreted as illustrative and not in a limiting sense. By way of example, those skilled in the art should appreciate that items 102, 103, 104, 106, 108, 110, and 112 may be constructed, connected, arranged, and/or combined in other formats, such as software modules, without departing from the scope of the invention. Additionally by way of example, those skilled in the art should appreciate that items 301, 303, 305, and 306 may be constructed, connected, arranged, and/or combined in other formats without departing from the scope. Another intention includes an understanding that the following claims are to cover all generic and specific features of the invention described herein, and all statements of the scope of the invention which, as a matter of language, might be said to fall there between.

1. A method for analyzing design elements in a CAD tool design comprising the steps of:
for each configuration command in a configuration file:
encoding information in the configuration command to generate a configuration element;
ordering the configuration element with a sequence number indicating the order in which the configuration command appeared in the configuration file; and
storing the configuration element in computer memory; and
for each said design element of interest:
applying each of the configuration elements stored in said computer memory to the design element of interest in an order indicated by the sequence number to analyze the design.

2. The method of claim 1, including the steps of:
storing the configuration element in a first list if the configuration element is a partial specifier;
storing the configuration element in a second list if the configuration element is a complete specifier;
evaluating each partial specifier in the first list to determine if the evaluated partial specifier matches the design element of interest;
retrieving the configuration element into a third list if the evaluated partial specifier matches the particular configuration element; and
retrieving, into the third list, each complete specifier in the second list that matches the particular configuration element.

3. The method of claim 2, including the step of discarding the third list from said computer memory after the configuration elements therein have been applied to the design element of interest.

4. The method of claim 2, wherein said complete specifier comprises a name of one of said design elements, and wherein said partial specifier comprises a regular expression, that, when evaluated, yields said name.

5. The method of claim 1, wherein the configuration element comprises design element information, and wherein the design element is selected from the group of design elements consisting of a transistor, a wire, a capacitor, a resistor, a diode, an operational amplifier, a logic gate, a hierarchical sub-design, and a power supply.

6. A method for analyzing design elements in a CAD tool design comprising the steps of:
for each configuration command in a configuration file:
encoding information in the configuration command to generate a configuration element;
ordering the configuration element with a sequence number indicating the order in which the configuration command appeared in the configuration file;
storing the configuration element in a first list if the configuration element is a partial specifier; and
storing the configuration element in a second list if the configuration element is a complete specifier;
for each said design element of interest:
evaluating each partial specifier in the first list to determine if the evaluated partial specifier matches the design element of interest;
retrieving the configuration element into a third list if the evaluated partial specifier matches the particular configuration element; and
retrieving, into the third list, each complete specifier in the second list that matches the particular configuration element;
applying each of the configuration elements in the third list to the design element of interest in an order indicated by the sequence number; and
discarding the third list from said computer memory after the configuration elements therein have been applied to the design element of interest.

7. The method of claim 6, wherein said complete specifier comprises a name of one of said design elements, and wherein said partial specifier comprises a regular expression, that, when evaluated, yields said name.

8. A system for analyzing design elements in a CAD tool design comprising:
a configuration element generator for encoding information in a configuration command to generate a configuration element associated with at least one of the design elements;
a sequencer coupled to the configuration element generator for tagging the configuration element with a sequence number;
computer memory, coupled to the sequencer, for storing the configuration element; and
a processor coupled to said computer memory, for applying, to said design element that is of interest, each stored said configuration element associated with said design element of interest, in an order indicated by the sequence number.

9. The system of claim 8, wherein the configuration element generator comprises a controller for generating the configuration element by selecting said configuration command from a configuration file.

10. The system of claim 9, wherein said controller:
stores the configuration element in a first list if the configuration element is a partial specifier, and stores the configuration element in a second list if the configuration element is a complete specifier;
evaluates each partial specifier in the first list to determine if the evaluated partial specifier matches the design element of interest;
retrieves the configuration element into the third list if the evaluated partial specifier matches the particular configuration element; and
retrieves, into the third list, each complete specifier in the second list that matches the particular configuration element.

11. The method of claim 10, wherein said complete specifier comprises a name of one of said design elements, and wherein said partial specifier comprises a regular expression, that, when evaluated, yields said name.

12. A system for analyzing design elements in a CAD tool design comprising:
encoding means for encoding information in a configuration command to generate a configuration element associated with at least one of the design elements;
sequencing means, coupled to said encoding means, for tagging the configuration element with a sequence number;
storage means, coupled to said sequencing means, for storing the configuration element; and
processing means, coupled to said sequencing means and to said storage means, for applying, to said design element that is of interest, each stored said configuration element associated with said design element of interest, in an order indicated by the sequence number, to analyze the design.

13. The system of claim 12, wherein the design element is selected from the group of design elements consisting of a transistor, a wire, a capacitor, a resistor, a diode, an operational amplifier, a logic gate, a hierarchical sub-design, and a power supply.

14. A system for analyzing design elements in a CAD design comprising:
a model generator for receiving design information from a design file to generate the CAD design;
a storage unit coupled to the model generator for storing the CAD design;
a configuration element generator for receiving configuration commands from a configuration file to generate a list of configuration elements associated with specific design elements of the CAD design; and
an analysis engine coupled to the storage unit and to the configuration element generator for analyzing one of the design elements at a time using information in the list of configuration elements.

15. The system of claim 14, wherein the configuration element generator is coupled to the storage unit for storing the configuration elements to allow reuse of the configuration elements as determined by the analysis engine.

16. The system of claim 15, wherein the list of configuration elements is discarded after said one of the design elements is analyzed.

17. The system of claim 16, wherein the design elements are selected from the group consisting of a transistor, a wire, a capacitor, a resistor, a diode, an operational amplifier, a logic gate, a hierarchical sub-design, and a power supply.

18. A software product comprising instructions, stored on computer-readable media, wherein the instructions, when executed by a computer, perform steps for analyzing design elements in a CAD tool design, comprising:
for each configuration command in a configuration file:
encoding information in the configuration command to generate a configuration element;
ordering the configuration element with a sequence number indicating the order in which the configuration command appeared in the configuration file; and
storing the configuration element in computer memory; and
for each said design element of interest:
applying each of the configuration elements stored in said computer memory to the design element of interest in an order indicated by the sequence number to analyze the design.

19. The software product of claim 18, including instructions for performing the steps of:
storing the configuration element in a first list if the configuration element is a partial specifier;
storing the configuration element in a second list if the configuration element is a complete specifier;
evaluating each partial specifier in the first list to determine if the evaluated partial specifier matches the design element of interest;
retrieving the configuration element into a third list if the evaluated partial specifier matches the particular configuration element; and
retrieving, into the third list, each complete specifier in the second list that matches the particular configuration element.

20. The software product of claim 19, including instructions for performing the step of discarding the third list from said computer memory after the configuration elements therein have been applied to the design element of interest.
